(19) United States
(12) Patent Application Publication
(10) Pub. No.: US 2016/0345014 A1
(43) Pub. Date: Nov. 24, 2016

(54) SYSTEMS AND METHODS FOR CODING A NUMBER OF PALETTE INDICES

(71) Applicant: Sharp Laboratories of America, Inc., Camas, WA (US)

(72) Inventors: Seung-Hwan KIM, Vancouver, WA (US); Kiran Mukesh MISRA, Camas, WA (US); Jie ZHAO, Vancouver, WA (US); Christopher Andrew SEGALL, Vancouver, WA (US)

(21) Appl. No.: 15/156,078

(22) Filed: May 16, 2016

Related U.S. Application Data
(60) Provisional application No. 62/164,460, filed on May 20, 2015.

(51) Int. Cl. H04N 19/186; H04N 19/50

(52) U.S. Cl. CPC H04N 19/186; H04N 19/50

(57) ABSTRACT

A video coding device may be configured to determine the absolute value of the difference of the number of palette indices signalled for a current coding unit and a predictor term. The predictor term may be based on a maximum possible value for a palette index for the current coding unit. Upon determining that the absolute value of the difference of the number of palette indices signalled for a current coding unit and a predictor term, the video coding device may be configured to generate a sign value.

### RELATED APPLICATIONS

This application claims the benefit of U.S. Provisional Application No. 62/164,460, filed on May 20, 2015, which is incorporated by reference in its entirety.

### TECHNICAL FIELD

This disclosure relates to video coding and more particularly to techniques for coding syntax elements.

### BACKGROUND

Digital video capabilities can be incorporated into a wide range of devices, including digital televisions, including so-called smart televisions, laptop or desktop computers, tablet computers, digital recording devices, digital media players, video gaming devices, cellular telephones, including so-called “smart” phones, medical imaging devices, and the like. Digital video may be coded according to a video coding standard. Examples of video coding standards include ISO/IEC MPEG-4 Visual and ITU-T H.264 (also known as ISO/IEC MPEG-4 AVC) and High-Efficiency Video Coding (HEVC), ITU-T H.265 and ISO/IEC 23008-2 MPEG-H. Extensions for HEVC are currently being developed. Video coding standards may incorporate video compression techniques.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, coding units within a coding block, etc.). Spatial techniques (i.e., intra-frame coding) and/or temporal techniques (i.e., inter-frame coding) may be used to generate a difference value between a coding unit to be coded and a reference coding unit. The difference value may be referred to as residual data. Residual data may be coded as quantized transform coefficients. Syntax elements (e.g., motion vectors and block vectors) may relate residual data and a reference coding unit. Residual data and syntax elements may be entropy coded. Current techniques for coding syntax elements may be less than ideal.

### SUMMARY

In general, this disclosure describes various techniques for coding syntax elements for predictive video coding. In particular, this disclosure describes techniques for coding syntax elements associated with palette coding. Palette coding may also be referred to as color table coding. It should be noted that although techniques of this disclosure are described with respect to the ITU-T H.264 standard and the ITU-T H.265 standard, the techniques of this disclosure are generally applicable to any video coding standard.

In one example, a method of encoding a syntax element associated with video data comprises determining a number of palette indices signalled for a current coding unit, and generating an indication of the number of palette indices signalled for a current coding unit, wherein generating the indication includes determining the absolute value of the difference of the number of palette indices signalled for a current coding unit and a predictor term.

In one example, a device for video encoding comprises one or more processors configured to determine a number of palette indices signalled for a current coding unit, and generate an indication of the number of palette indices signalled for a current coding unit, wherein generating the indication includes determining the absolute value of the difference of the number of palette indices signalled for a current coding unit and a predictor term.

In one example, a non-transitory computer-readable storage medium comprises instructions stored thereon that, when executed, cause one or more processors of a device for encoding video data to determine a number of palette indices signalled for a current coding unit, and generate an indication of the number of palette indices signalled for a current coding unit, wherein generating the indication includes determining the absolute value of the difference of the number of palette indices signalled for a current coding unit and a predictor term.

In one example, an apparatus for encoding video data apparatus comprises means for determining a number of palette indices signalled for a current coding unit, and means for generating an indication of the number of palette indices signalled for a current coding unit, wherein generating the indication includes determining the absolute value of the difference of the number of palette indices signalled for a current coding unit and a predictor term.

In one example, a method of decoding a syntax element associated with video data comprises parsing a syntax element indicating the absolute value of the difference of the number of palette indices signalled for a current coding unit and a predictor term and determining the number of palette indices signalled for a current coding unit based on the syntax element.

In one example, a device for decoding video data comprises one or more processors configured to parse a syntax element indicating the absolute value of the difference of the number of palette indices signalled for a current coding unit and a predictor term and determine the number of palette indices signalled for a current coding unit based on the syntax element.

In one example, a non-transitory computer-readable storage medium comprises instructions stored thereon that, when executed, cause one or more processors of a device for decoding video data to parse a syntax element indicating the absolute value of the difference of the number of palette indices signalled for a current coding unit and a predictor term and determine the number of palette indices signalled for a current coding unit based on the syntax element.

In one example, an apparatus for decoding video data comprises means for parsing a syntax element indicating the absolute value of the difference of the number of palette indices signalled for a current coding unit and a predictor term and means for determining the number of palette indices signalled for a current coding unit based on the syntax element.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a system that may be configured to encode and decode video data according to one or more techniques of this this disclosure.

FIG. 2 is a block diagram illustrating an example of a video encoder that may be configured to encode video data according to one or more techniques of this disclosure.

FIG. 3 is a block diagram illustrating an example of an entropy encoder that may be configured to encode syntax elements according to one or more techniques of this disclosure.

FIG. 4 is a flowchart illustrating encoding palette coding syntax elements according to one or more techniques of this disclosure.

FIG. 5 is a block diagram illustrating an example of a video decoder that may be configured to decode video data according to one or more techniques of this disclosure.

FIG. 6 is a block diagram illustrating an example of an entropy decoder that may be configured to decode syntax elements according to one or more techniques of this disclosure.

FIG. 7 is a flowchart illustrating decoding palette coding syntax elements according to one or more techniques of this disclosure.

FIG. 8 is a conceptual diagram illustrating palette table generation.

FIG. 9 is a conceptual diagram illustrating palette table index map coding.

### DETAILED DESCRIPTION

Video content typically includes video sequences comprised of a series of frames. A series of frames may also be referred to as a group of pictures (GOP). Each video frame or picture may include a plurality of slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may refer to the largest array of pixel values that may be predictively coded, sub-divisions thereof, and/or corresponding structures.

In ITU-T H.265, the CTBs of a CTU may be partitioned into Coding Blocks (CB) according to a corresponding quadtree data structure. According to ITU-T H.265 one luma CB together with two corresponding chroma CBs and associated syntax elements is referred to as a coding unit (CU). A CU is associated with a prediction unit (PU) structure defining one or more prediction units (PU) for the CU, where a PU is associated with corresponding reference samples. For example, a PU of a CU may be an array of samples coded according to an intra-prediction mode. Specific intra-prediction mode data (e.g., intra-prediction syntax elements) may associate the PU with corresponding reference samples. In ITU-T H.265 a PU may include luma and chroma prediction blocks (PBs) where square PBs are supported for intra-picture prediction and rectangular PBs are supported for inter-picture prediction. The difference between sample values included in a PU and associated reference samples may be referred to as residual data.

Residual data may include respective arrays of difference values corresponding to each component of video data (e.g., luma (Y) and chroma (Cb and Cr). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that according to ITU-T H.265, PUs may be further sub-divided into Transform Units (TUs). That is, an array of pixel difference values may be sub-divided for purposes of generating transform coefficients (e.g., four 8×8 transforms may be applied to a 16×16 array of residual values), such sub-divisions may be referred to as Transform Blocks (TBs). Transform coefficients may be quantized according to a quantization parameter (QP). Quantized transform coefficients may be entropy coded according to an entropy encoding technique (e.g., content adaptive variable length coding (CAVLC), context adaptive binary arithmetic coding (CABAC), or probability interval partitioning entropy coding (PIPE)). Further, syntax elements, such as, a syntax element defining a prediction mode, may also be entropy coded. Entropy encoded quantized transform coefficients and corresponding entropy encoded syntax elements may form a compliant bitstream that can be used to reproduce video data.

As described above, prediction syntax elements may associate a video block and PUs thereof with corresponding reference samples. For example, for intra-prediction coding, an intra-prediction mode may specify the location of reference samples. In ITU-T H.265, possible intra-prediction modes for a luma component include a planar prediction mode (predMode: 0), a DC prediction (predMode: 1), and 33 angular prediction modes (predMode: 2-34). One or more syntax elements may identify one of the 35 intra-prediction modes. For inter-prediction coding, a motion vector (MV) identifies reference samples in a picture other than the picture of a video block to be coded and thereby exploits temporal redundancy in video. For example, a current video block may be predicted from a reference block located in a previously coded frame and a motion vector may be used to indicate the location of the reference block. A motion vector and associated data may describe, for example, a horizontal component of the motion vector, a vertical component of the motion vector, a resolution for the motion vector (e.g., one-quarter pixel precision), a prediction direction and/or a reference picture index value. Further, a coding standard, such as, for example ITU-T H.265, may support motion vector prediction. Motion vector prediction enables a motion vector to be specified using motion vectors of neighboring blocks.

As described above, extensions to ITU-T H.265 are currently being developed. One extension includes the so-called High Efficiency Video Coding (HEVC) Screen Content Coding. High Efficiency Video Coding (HEVC) Screen Content Coding may be particularly useful for graphics, text, mixtures of graphics and text with camera-view video (e.g., subtitles), 4:4:4 chroma sampling, and near-lossless or lossless encoding. A recent draft of High Efficiency Video Coding (HEVC) Screen Content Coding is described in Joshi et al. High Efficiency Video Coding (HEVC) Screen Content Coding Draft Text 3, JCTVC-T1005” Joint Collaborative Team on Video Coding (JCT-VC) of ITU-T SG 16 WP 3 and ISO/IEC JTC1/SC29/WG11, 20th Meeting: Geneva, CH, 10-17 Feb. 2015 (hereinafter “JCTVC-T1005”), which is incorporated by reference herein in its entirety.

In addition to performing intra-prediction coding according to the 35 prediction modes described above, JCTVC-T1005 specifies a palette coding mode that may be used for intra-prediction coding. Palette coding enables a current CU to be coded based on a palette (which may also be referred to as a palette table or a color table), where a palette includes index values associated with color values (e.g., RGB values) and color values for respective pixels within a CU are derived by referencing an index value and thus, the color value referenced by the index value. It should be noted that in other examples, an index value may reference other types of values that may be used to derive a sample value. For example, an index value may reference a grayscale value, a luma value, a chroma value, an individual color component value, a difference value, or the like. Palette coding may be particularly useful for coding regions of a picture that include a relatively limited number of solid colors, as may be the case with icons, text, graphics, and the like.

The process of palette coding may generally be described as including two elements (1) palette table generation and (2) index map coding. Palette table generation may refer to the process of selecting and/or generating a palette table for a current CU. Index map coding may refer to the process of deriving color values for each pixel in the current CU based on the generated palette table. A palette table may be defined using one or more syntax elements. It should be noted that syntax elements used for palette table generation may also be used for index map coding. In JCTVC-T1005, high-level properties of palette coding may be set for a video sequence. In JCTVC-T1005, the sequence parameter set (SPS) includes syntax elements palette_mode_enabled_flag, palette_max_size, and delta_palette_max_predictor_size, each of which is respectively defined as follows:
palette_mode_enabled_flag equal to 1 specifies that the palette mode may be used for intra blocks. palette_mode_enabled_flag equal to 0 specifies that the palette mode is not applied. When not present, the value of palette_mode_enabled_flag is inferred to be equal to 0.
palette_max_size specifies the maximum allowed palette size. When not present, the value of palette_max_size is inferred to be 0.
delta_palette_max_predictor_size specifies the difference between the maximum allowed palette predictor size and the maximum allowed palette size. When not present, the value of delta_palette_max_predictor_size is inferred to be 0. The variable PaletteMaxPredictorSize is derived as follows:

PaletteMaxPredictorSize=palette_max_size+delta_palette_max_predictor_size

Further, JCTVC-T1005 includes the syntax element palette_mode_flag in the coding unit semantics, defined as follows:
palette_mode_flag[x0][y0] equal to 1 specifies that the current coding unit is coded using the palette mode. palette_mode_flag[x0][y0] equal to 0 specifies that the current coding unit is not coded using the palette mode. The array indices x0 and y0 specify the location (x0, y0) of the top-left luma sample of the considered coding block relative to the top-left luma sample of the picture. When palette_mode_flag[x0][y0] is not present, it is inferred to be equal to 0.

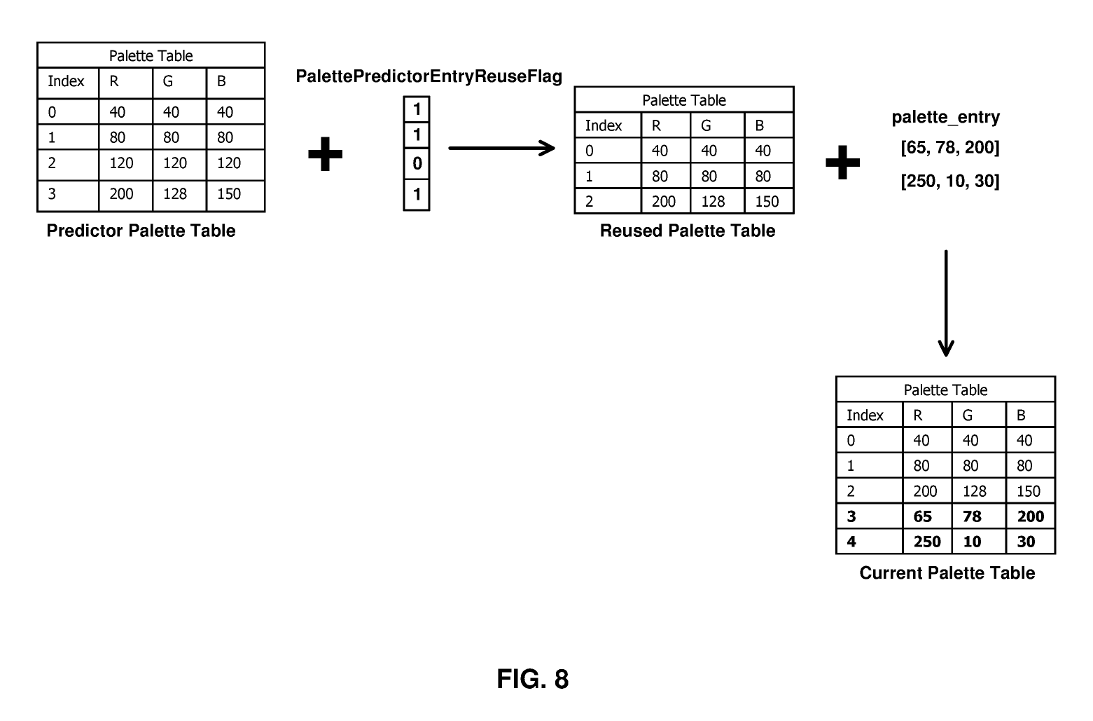

FIG. 8 is a conceptual diagram illustrating palette table generation. In the example illustrated in FIG. 8, a current palette table is generated based on a predictor palette table. A predictor palette table may include a predefined available palette table (e.g., a palette table defined for a sequence or slice) or a palette table used to palette code a previous CU. In the example illustrated in FIG. 8, a reused palette table is generated using a predictor palette table. As illustrated in FIG. 8, a palette predictor entry reuse flag, PalettePredictorEntryReuseFlag, is used to indicate whether or not the corresponding entry of the predictor palette table is in the current palette table. JCTVC-T1005 defines a PalettePredictorEntryReuseFlag variable as follows:
The variable PalettePredictorEntryReuseFlag[i] equal to 1 specifies that the i-th entry in the predictor palette is reused in the current palette. PalettePredictorEntryReuseFlag[i] equal to 0 specifies that the i-th entry in the predictor palette is [not] an entry in the current palette. All elements of the array PalettePredictorEntryReuseFlag[i] are initialized to be equal to zero.

Thus, as illustrated in FIG. 8, when the PalettePredictorEntryReuseFlag corresponding to an index equals one, the color value corresponding to the index is included in a reused palette table. As further illustrated in FIG. 8, entries may be added to a reused palette table to generate a current palette table. Palette entries added (e.g., appended) to a reused palette table may be explicit signaled (e.g., [65, 78, 200] and [250, 10, 30] in FIG. 8). Further, the number of palette entries to be added may be signalled. JCTVC-T1005 includes syntax elements num_signalled_palette_entries and palette_entry, each of which is respectively defined as follows:
num_signalled_palette_entries specifies the number of entries in the current palette that are explicitly signalled. When num_signalled_palette_entries is not present, it is inferred to be equal to 0. The variable CurrentPaletteSize specifies the size of the current palette and is derived as follows:

CurrentPaletteSize=NumPredictedPaletteEntries+num_signalled_palette_entries
The value of CurrentPaletteSize shall be in the range of 0 to palette_max_size, inclusive. The variable NumPredictedPaletteEntries specifies the number of entries in the current palette that are reused from the predictor palette. The value of NumPredictedPaletteEntries shall be in the range of 0 to palette_max_size, inclusive.
palette_entry specifies the value of a component in a palette entry for the current palette. The variable PredictorPaletteEntries[cIdx][i] specifies the i-th element in the predictor palette for the colour component cIdx.

Thus, as illustrated in FIG. 8, a current palette table may be generated by using a predictor palette table, a palette predictor entry reuse flag, and by signaling additional palette entries. It should be noted that the techniques described herein are generally applicable regardless of how a palette table is generated.

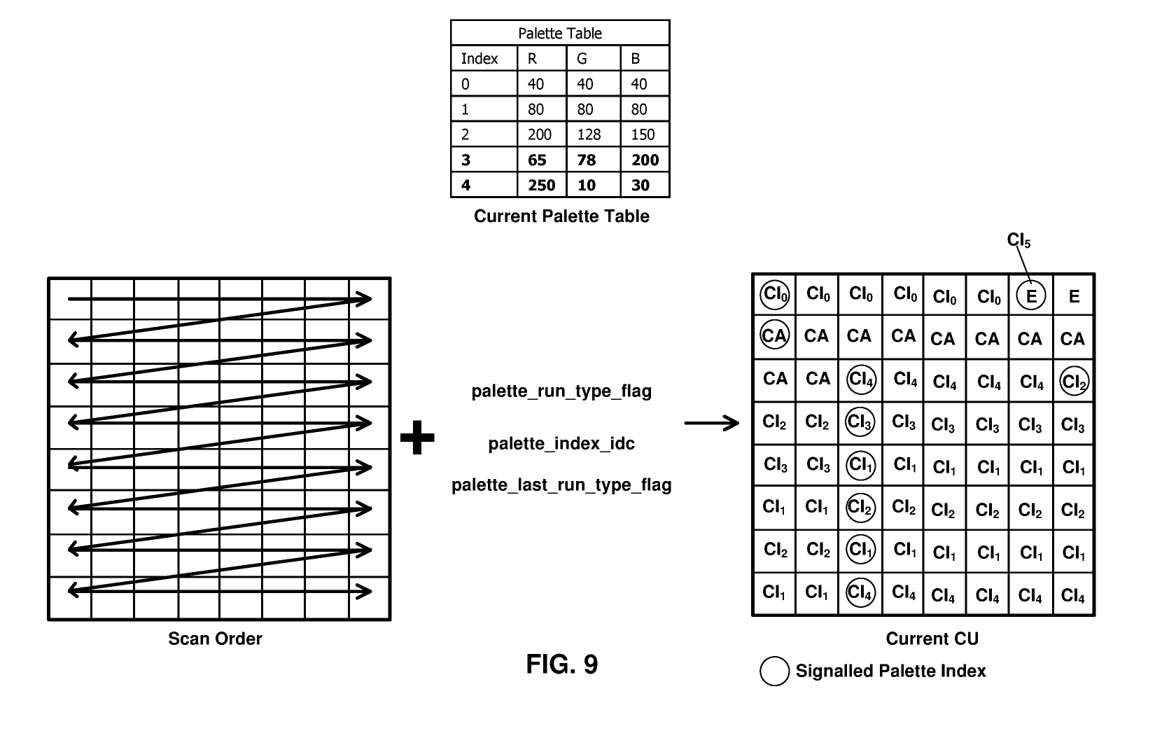

FIG. 9 is a conceptual diagram illustrating palette table index map coding. In the example illustrated in FIG. 9, after a current palette table is generated, each pixel in a current CU is coded based on the current palette table. A pixel in a CU may be coded according to a scan order. In the example illustrated in FIG. 9, a horizontal scan order is used. In one example, each pixel in a CU may be coded using one of three coding modes: (1) a copy index mode, (2) a copy above mode, and (3) an escape mode. A copy index mode may specify that an indication of the palette index of the sample is coded in the bitstream. A copy above mode may specify that the palette index is equal to the palette index at the same location in the row above. In one example, indications of copy index mode and copy above mode may be coded using run type coding (e.g., next 8 samples in scan coded using copy above mode, next 6 samples in scan coded using copy index mode, etc.). An escape mode may indicate that the quantized pixel value is transmitted directly. In one example, escape mode may be classified in a copy index mode and may be identified by using a unique index value. That is, an escape mode may be a signalled as a special case of a copy index mode. For example, escape mode may be identified when an index value is equal to CurrentPaletteSize. JCTVC-T1005 includes syntax elements palette_index_idc, palette_run_type_flag, and palette_last_run_type_flag, each of which are respectively defined as follows:
palette_index_idc is an indication of an index to the array represented by currentPaletteEntries (The variable CurrentPaletteEntries[cIdx][i] specifies the i-th element in the current palette for the colour component cIdx). The value of palette_index_idc shall be in the range of 0 to MaxPaletteIndex (The variable MaxPaletteIndex specifies the maximum possible value for a palette index for the current coding unit), inclusive, for the first index in the block and in the range of 0 to (MaxPaletteIndex−1), inclusive for the remaining indices in the block. When palette_index_idc is not present, it is inferred to be equal to 0.
palette_runtype_flag[xC][yC] equal to COPY_ABOVE_MODE specifies that the palette index is equal to the palette index at the same location in the row above. palette_run_type_flag[xC][yC] equal to COPY_INDEX_MODE specifies that an indication of the palette index of the sample is coded in the bitstream. The array indices xC, yC specify the location (xC, yC) of the sample relative to the top-left luma sample of the picture.
palette_last_run_type_flag specifies the last occurrence of the palette_run_type_flag within the block.

In the example illustrated in FIG. 9, the example current CU is illustrated as being coded using a copy index mode (which includes escape mode), where CIₓ indicates a copy index mode for a pixel, E indicates an escape mode for a sample, which signaled using a copy index mode (i.e., x=5). Further, the example current CU is illustrated as being coded using a copy above mode, where CA indicates a copy above mode.

JCTVC-T1005 includes syntax elements palette_escape_val_present_flag and num_palette_indices_idc, which may be used for index map coding, each of which is respectively defined as follows:
palette_escape_val_present_flag equal to 1 specifies that the current coding unit contains at least one escape coded sample. palette_escape_val_present_flag equal to 0 specifies that there are no escape coded samples in the current coding unit. When not present, the value of palette_escape_val_present_flag is inferred to be equal to 1. The variable MaxPaletteIndex specifies the maximum possible value for a palette index for the current coding unit. The value of MaxPaletteIndex is set equal to CurrentPaletteSize−1+palette_escape_val_present_flag.
num_palette_indices_idc is an indication of the number of palette indices signalled for the current block. When num_palette_indices_idc is not present, it is inferred to be equal to 0. The variable NumPaletteIndices specifies the number of palette indices signalled for the current block and is derived as follows:

if(num_palette_indices_idc>=(MaxPaletteIndex−1)*32)

NumPaletteIndices=num_palette_indices_idc+1

else if(num_palette_indices_idc % 32==31)

NumPaletteIndices=MaxPaletteIndex−(num_palette_indices_idc+1)/32

else

NumPaletteIndices=(num_palette_indices_idc/32)*31)+(num_palette_indices_idc % 32)+MaxPaletteIndex
where
   >= is a relational greater than or equal to operator;
   % is a modulus arthimetic operator, where x % y is remainder of x divided
   by y, defined only for integers x and y with x>=0 and y>0;
   / is integer division with truncation of the result towards zero; and
   == is a relational greater than or equal to operator.

It should be noted that although the variable NumPaletteIndices is described in JCTVC-T1005 as “specifying the number of palette indices signalled for the current block,” based on the Palette Syntax provided in JCTVC-T1005, NumPaletteIndices may be described as specifying the number of explicitly signalled palette index values and explicitly signalled copy above mode runs for a current CU. As used herein the number of palette indices signalled for the current block may include the number of signalled palette index values and the number of signalled copy above mode runs. In the example illustrated in FIG. 9, signalled palette index values and signalled copy above mode runs are circled. Thus, in the example illustrated in FIG. 9, the number of palette indices signalled for the current block (i.e., NumPaletteIndices) is equal to 10.

In the example illustrated in FIG. 9, for the current CU palette_escape_val_present_flag equals 1 (i.e., at least one sample in Current CU is coded using an escape mode), and MaxPaletteIndex equals five (i.e., 5−1+1). Using the conditional statement provided above num_palette_indices_idc can provide an indication of NumPaletteIndices. That is, a decoder receiving a num_palette_indices_idc value may derive NumPaletteIndices. In the example illustrated in FIG. 9, num_palette_indices_idc equals 10 and a decoder receiving a num_palette_indices_idc value equal to 10 may derive a NumPaletteIndices value of 10.

As described above, syntax elements may be entropy coded according to an entropy encoding technique. In JCTVC-T1005 num_palette_indices_idc is entropy encoded according to a CABAC entropy encoded technique. To apply CABAC coding to a syntax element, a video encoder may perform binarization on a syntax element. Binarization refers to the process of converting a syntax value into a series of one or more bits. These bits may be referred to as “bins.” For example, binarization may include representing the integer value of 5 as 00000101 using an 8-bit fixed length technique or as 11110 using a unary coding technique. Binarization is a lossless process and may include one or a combination of the following coding techniques: fixed length coding, unary coding, truncated unary coding, truncated Rice coding, Golomb coding, k-th order exponential Golomb coding, and Golomb-Rice coding. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265. In some examples, the techniques described herein may be generally applicable to bin values generated using any binarization coding technique.

After binarization, a CABAC entropy encoder may select a context model. For a particular bin, a context model may be selected from a set of available context models associated with the bin. It should be noted that in ITU-T H.265, a context model may be selected based on a previous bin and/or syntax element. A context model may identify the probability of a bin being a particular value. For instance, a context model may indicate a 0.7 probability of coding a 0-valued bin and a 0.3 probability of coding a 1-valued bin. After selecting an available context model, a CABAC entropy encoder may arithmetically code a bin based on the identified context model.

As described above, ITU-T H.265 defines specific binarizations. In one example, a Fixed-length (FL) binarization process may be defined according to ITU-T H.265 as follows:
Inputs to this process are a request for a FL binarization and cMax (the largest possible value of the syntax element)
Output of this process is the FL binarization associating each value symbolVal with a corresponding bin string.
FL binarization is constructed by using the fixedLength bit unsigned integer bin string of the symbol value symbolVal, where fixedLength=Ceil(Log 2(cMax+1)). The indexing of bins for the FL binarization is such that the binIdx=0 relates to the most significant bit with increasing values of binIdx towards the least significant bit.

Further, in one example, a Truncated Rice (TR) binarization process may be defined according to ITU-T H.265 as follows:
Input to this process is a request for a truncated Rice (TR) binarization, cMax and cRiceParam.
Output of this process is the TR binarization associating each value symbolVal with a corresponding bin string.
A TR bin string is a concatenation of a prefix bin string and, when present, a suffix bin string.
   For the derivation of the prefix bin string, the following applies:
The prefix value of symbolVal, prefixVal, is derived as follows:

prefixVal=symbolVal>>cRiceParam
The prefix of the TR bin string is specified as follows:
If prefixVal is less than cMax>>cRiceParam, the prefix bin string is a bit string of length prefixVal+1 indexed by binIdx. The bins for binIdx less than prefixVal are equal to 1. The bin with binIdx equal to prefixVal is equal to 0. Table [1] illustrates the bin strings of this unary binarization for prefixVal.
Otherwise, the bin string is a bit string of length cMax>>cRiceParam with all bins being equal to 1.

TABLE [1]
Bin string of the unary binarization (informative)

| prefixVal | Bin string | | | | | |
|---|---|---|---|---|---|---|
| 0 | 0 | | | | | |
| 1 | 1 | 0 | | | | |
| 2 | 1 | 1 | 0 | | | |
| 3 | 1 | 1 | 1 | 0 | | |
| 4 | 1 | 1 | 1 | 1 | 0 | |
| 5 | 1 | 1 | 1 | 1 | 1 | 0 |
| . . . | | | | | | |
| binIdx | 0 | 1 | 2 | 3 | 4 | 5 |

When cMax is greater than symbolVal and cRiceParam is greater than 0, the suffix of the TR bin string is present and it is derived as follows:
The suffix value suffixVal is derived as follows:

suffixVal=symbolVal−((prefixVal)<<cRiceParam)
The suffix of the TR bin string is specified by invoking the fixed-length (FL) binarization process as specified [above] for suffixVal with a cMax value equal to (1<<cRiceParam)−1.
where
x>>y is an arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation; and
x<<y is an arithmetic left shift of a two's complement integer representation of x by y binary digits. This function is defined only for non-negative integer values of y. Bits shifted into the least significant bits (LSBs) as a result of the left shift have a value equal to 0.

Further, in ITU-T H.265, EGk represents a k-th order Exp-Golomb binarization process. In one example, a k-th order Exp-Golomb (EGk) binarization process may be defined according to ITU-T H.265 as follows:
Inputs to this process is a request for an EGk binarization.
Output of this process is the EGk binarization associating each value symbolVal with a corresponding bin string.
The bin string of the EGk binarization process for each value symbolVal is specified as follows, where each call of the function put(X), with X being equal to 0 or 1, adds the binary value X at the end of the bin string:

```
absV = Abs( symbolVal )
stopLoop = 0
do
    if( absV >= ( 1 << k ) ) {
        put( 1 )
        absV = absV − ( 1 << k )
        k++
    } else {
        put( 0 )
        while( k−− )
            put( ( absV >> k ) & 1 )
        stopLoop = 1
    }
while( !stopLoop )
```

It should be noted that for one example, k-th order Exp-Golomb (EGk) code 1's and 0's may be used in reverse meaning for the unary part of the Exp-Golomb code of 0-th order.

As described above, for a particular syntax element, a binarization may include a combination of binarization techniques. In JCTVC-T1005 the binarization of num_palette_indices_idc is defined as follows:
Input to this process is a request for a binarization for the syntax element num_palette_indices_idc, MaxPaletteIndex, and nCbS (specifies the size of the current luma coding block).
Output of this process is the binarization of the syntax element.
The variables cRiceParam is derived as follows:

cRiceParam=2+MaxPaletteIndex/6
The variable cMax is derived from cRiceParam as:

cMax=4<<cRiceParam
The binarization of the syntax element num_palette_indices_idc is a concatenation of a prefix bin string and (when present) a suffix bin string. For the derivation of the prefix bin string, the following applies:
   The prefix value of num_palette_indices_idc, prefixVal, is derived as follows:

prefixVal=Min(cMax, num_palette_indices_idc)
The prefix bin string is specified by invoking the TR binarization process as specified [above] for prefixVal with the variables cMax and cRiceParam as inputs.
When the prefix bin string is equal to the bit string of length 4 with all bits equal to 1, the suffix bin string is present and it is derived as follows:
   The suffix value of num_palette_indices_idc, suffixVal, is derived as follows:

suffixVal=num_palette_indices_idc−cMax
The suffix bin string is specified by invoking the k-th order EGk binarization process as specified [above] for the binarization of suffixVal with the Exp-Golomb order k set equal to cRiceParam+1.

Performing palette coding according to the manner described above may be less than ideal. For example, the derivation of variable NumPaletteIndices from num_palette_indices_idc may be less than ideal. In one example, the techniques described herein may be used to more efficiently perform palette coding. Further, in one example, the techniques described herein may be used to more efficiently code syntax elements indicating the number of palette indices signalled for the current block. Further, the techniques described herein may include performing binarization on the syntax elements. It should be noted that because a picture may include a significant number of blocks coded using palette coding, by more efficiently performing paletted coding, overall coding efficiency may be improved, particularly in the case where a video includes graphics.

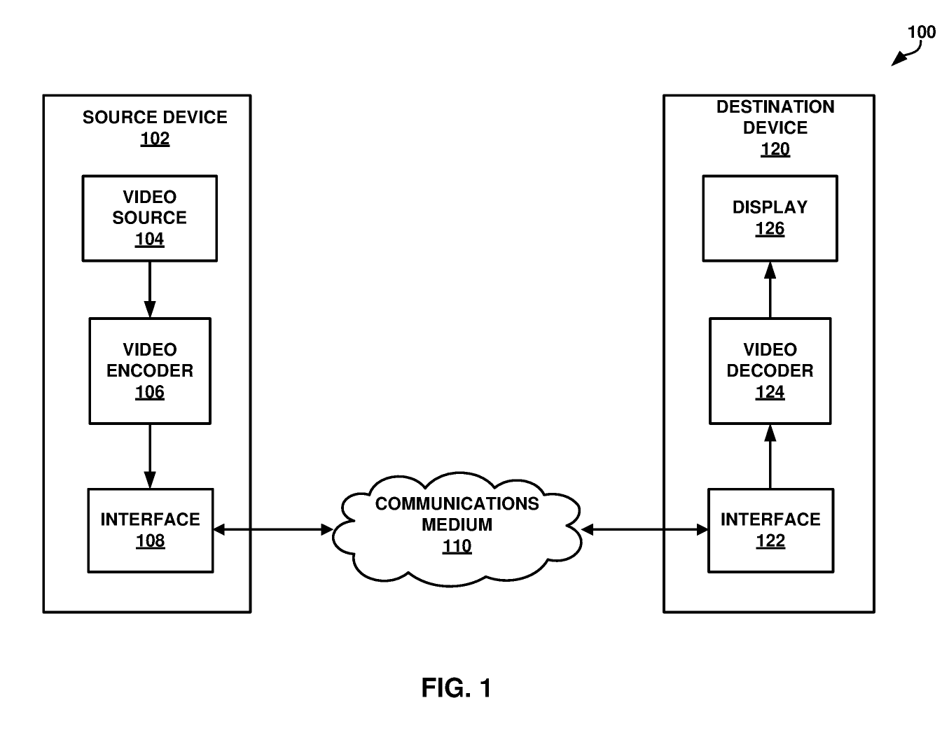

FIG. 1 is a block diagram illustrating an example of a system that may be configured to code (i.e., encode and/or decode) video data according to one or more techniques of this disclosure. System 100 represents an example of a system that may code syntax elements according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards.

Storage devices may include any type of device or storage medium capable of storing data. A storage medium may include tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format, such as, for example, a standardized media file format defined by ISO.

Referring again to FIG. 1, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard, such as, for example ITU-T H.265 and/or extensions thereof. When generating a compliant bitstream video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting PCI and PCIe bus protocols, proprietary bus protocols, Universal Serial Bus (USB) protocols, I²C, or any other logical and physical structure that may be used to interconnect peer devices.

Referring again to FIG. 1, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, Universal Serial Bus (USB) protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display.

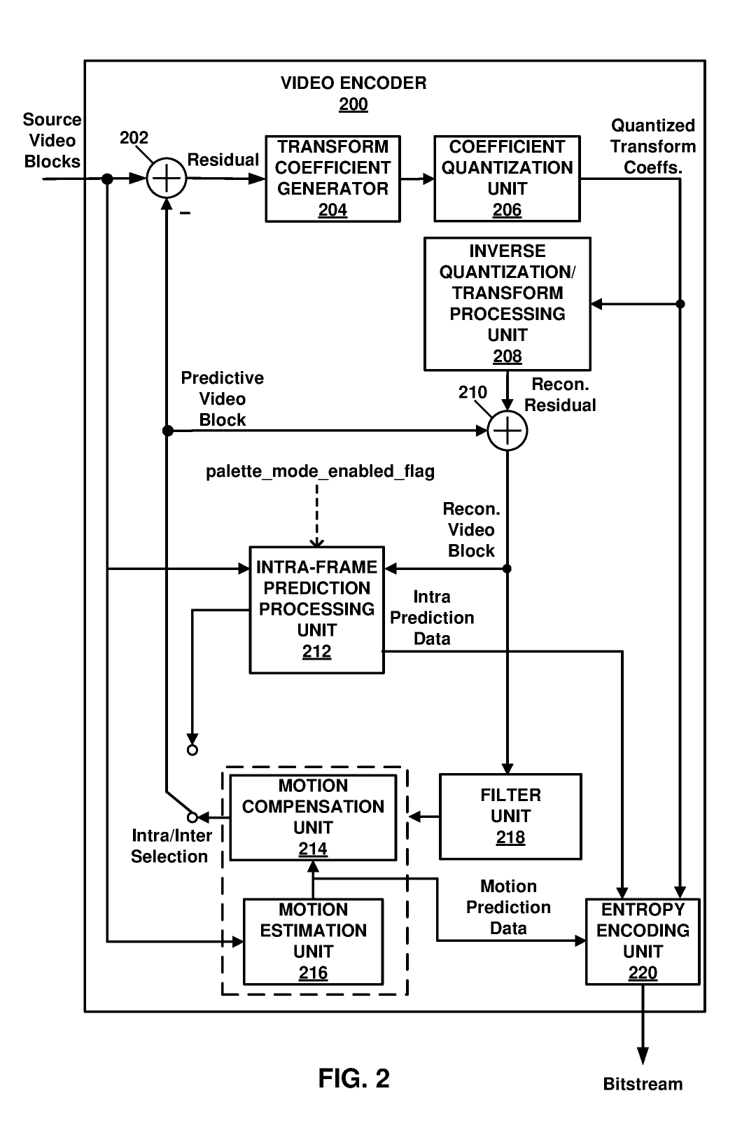

FIG. 2 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware and/or software implementations. In one example, video encoder 200 may be configured to determine a number of palette indices signalled for a current coding unit, and generate an indication of the number of palette indices signalled for a current coding unit, wherein generating the indication includes determining the absolute value of the difference of the number of palette indices signalled for a current coding unit and a predictor term.

Video encoder 200 may perform intra-prediction coding and inter-prediction coding of video blocks within video slices, and, as such, may be referred to as a hybrid video encoder. In the example illustrated in FIG. 2, video encoder 200 receives source video blocks that have been divided according to a coding structure. For example, source video data may include macroblocks, CTUs, sub-divisions thereof, and/or another equivalent coding unit. In some examples, video encoder may be configured to perform additional sub-divisions of source video blocks. It should be noted that the techniques described herein are generally applicable to video coding, regardless of how source video data is partitioned prior to and/or during encoding. In the example illustrated in FIG. 2, video encoder 200 includes summer 202, transform coefficient generator 204, coefficient quantization unit 206, inverse quantization/transform processing unit 208, summer 210, intra-frame prediction processing unit 212, motion compensation unit 214, motion estimation unit 216, filter unit 218, and entropy encoding unit 220. As illustrated in FIG. 2, video encoder 200 receives source video blocks and outputs a bitstream.

In the example illustrated in FIG. 2, video encoder 200 may generate residual data by subtracting a predictive video block from a source video block. The selection of a predictive video block is described in detail below. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may output residual transform coefficients to coefficient quantization unit 206.

Coefficient quantization unit 206 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting a quantization parameter (QP). As illustrated in FIG. 2, quantized transform coefficients are output to inverse quantization/transform processing unit 208. Inverse quantization/transform processing unit 208 may be configured to apply an inverse quantization and an inverse transformation to generate reconstructed residual data. As illustrated in FIG. 2, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra-prediction. Intra-frame prediction processing unit 212 may be configured to select an intra-frame prediction for a video block to be coded. Intra-frame prediction processing unit 212 may be configured to evaluate a frame and determine an intra-prediction mode to use to encode a current block. As described above, possible intra-prediction modes may include a planar prediction mode, a DC prediction mode, and angular prediction modes. Further, it should be noted that in some examples, a prediction mode for a chroma component may be inferred from an intra-prediction mode for a luma prediction mode. Intra-frame prediction processing unit 212 may select an intra-frame prediction mode after performing one or more coding passes. Further, in one example, intra-frame prediction processing unit 212 may select a prediction mode based on a rate-distortion analysis. As illustrated in FIG. 2, intra-frame prediction processing unit 212 outputs intra-prediction data (e.g., syntax elements) to entropy encoding unit 220.

As described above, some coding standards may support palette coding. In the example illustrated in FIG. 2, video encoder 200 and/or intra-frame prediction processing unit 212 are configured to support palette coding. In the example illustrated in FIG. 2, video encoder 200 and/or intra-frame prediction processing unit 212 may receive a control signal indicating that palette coding is supported for one or more frames of video data. For example, a syntax element (e.g., palette_mode_enabled_flag, described above) provided in a sequence parameter set may indicate that palette mode coding may be used for intra blocks within the sequence.

As further described above, coding a block using palette coding may include generating a syntax element that indicates the number of palette indices signalled for the current block. In one example, video encoder 200 and/or intra-frame prediction processing unit 212 may be configured to determine the number of palette indices signaled for a current block. For example, referring to Current Coding Unit illustrated in FIG. 9, video encoder 200 and/or intra-frame prediction processing unit 212 may be configured to determine that the number of palette indices signalled for Current Coding Unit equals 10. Video encoder 200 and/or intra-frame prediction processing unit 212 may be configured to generate syntax elements indicating the number of palette indices for a current coding unit. In one example, the syntax element may be defined according to a variable that specifies the number of palette indices for the current block. That is, similar to num_palette_indices_idc described above with respect to JCTVC-T1005 video encoder 200 and/or intra-frame prediction processing unit 212 may be configured to generate a syntax element defined according to derived variables.

In one example, video encoder 200 and/or intra-frame prediction processing unit 212 may be configured to generate syntax elements num_palette_indices_idc_abs and num_palette_indices_idc_sign_flag. In one example, num_palette_indices_idc_abs and num_palette_indices_idc_sign_flag may be defined as follows:
num_palette_indices_idc_abs is an absolute value of the indication of the number of palette indices signalled for the current block. The value of num_palette_indices_idc_abs equals abs(NumPaletteIndicesIdc), where abs(x) is the non-negative value of x. In one example, when num_palette_indices_idc_abs is not present or received, it is inferred to be equal to 0. The variable NumPaletteIndices specifies the number of palette indices signalled for the current block. The variable NumPaletteIndicesIdc is an indication of the number of palette indices signalled for the current block and is derived as follows:

NumPaletteIndicesIdc=NumPaletteIndices−PRED
num_palette_indices_idc_sign_flag specifies the sign of the indication of the number of palette indices signalled for the current block. In an example, num_palette_indices_idc_sign_flag equal to zero indicates positive (+) sign and num_palette_indices_idc_sign_flag equal to one indicates negative (−) sign. When num_palette_indices_idc_sign_flag is not present, it is inferred to be equal to 0.

In one example, PRED may indicate the expected value of the number of palette indices signalled for a current block. In one example, PRED may be dependent on the number of palette indices in a current palette table or MaxPaletteIndex. For example, PRED may equal X*MaxPaletteIndex, where X equals one of 1, 2, 3, 4, or another integer multiplier. Further, in other examples, PRED may be dependent on the size of the current CU, and/or PRED may be a predetermined constant value (e.g., 16). In one example, PRED equals 2*MaxPaletteIndex. In one example, PRED may equal X*MaxPalette−threshold, where threshold may include a predetermined constant value or a variable associated with a current CU. Further in one in example, PRED may equal nCbS−X*MaxPalette, where nCbS specifies the size of the current luma coding block. Taking PRED equals 2*MaxPaletteIndex, for the example illustrated in FIG. 9, NumPaletteIndicesIdc equals zero ((2*5)−10)=0.

In some cases where the value of NumPaletteIndices ranges from 1 to the current CU size, NumPaletteIndicesIdc may include positive and negative values. For example, referring again to the example illustrated in FIG. 9, if PRED=2*MaxPaletteIndex and MaxPaletteIndex equals 5, and if NumPaletteIndices equals 1 to 9, NumPaletteIndicesIdc is negative. More generally, when NumPaletteIndices is less than PRED, NumPaletteIndicesIdc will be negative.

An example of the relationship between variables NumPaletteIndices and NumPaletteIndicesIdc is illustrated in Table 2. It should be noted that in the example illustrated in Table 2, PRED is assumed to be greater than 3 (i.e., NumPaletteIndices does not include negative values).

TABLE 2

| NumPaletteIndices | NumPaletteIndicesIdc | num_palette_indices_idc_abs | num_palette_indices_idc_sign_flag |
|---|---|---|---|
| 1 | 1 − PRED | PRED − 1 | Received− |
| . . . | . . . | . . . | Received− |
| PRED − 3 | −3 | 3 | Received− |
| PRED − 2 | −2 | 2 | Received− |
| PRED − 1 | −1 | 1 | Received− |
| PRED | 0 | 0 | Inferred |
| PRED + 1 | 1 | 1 | Received+ |
| PRED + 2 | 2 | 2 | Received+ |
| PRED + 3 | 3 | 3 | Received+ |
| . . . | . . . | . . . | Received+ |
| 2 * PRED − 1 | PRED − 1 | PRED − 1 | Received+ |
| 2 * PRED | PRED | PRED | Inferred+ |
| . . . | . . . | . . . | Inferred+ |
| nCbS | nCbS − PRED | nCbS − PRED | Inferred+ |

Further, in this example, the negative and positive range of NumPaletteIndicesIdc is different. That is, the negative range of NumPaletteIndicesIdc is from 1-PRED to −1 and the positive range of NumPaletteIndicesIdc is from 1 to nCbS-PRED. In the example illustrated in FIG. 9, the value of NumPaletteIndicesIdc ranges from −9 to +54 for NumPaletteIndices ranging from 1 to 64. It should be noted that more generally, the negative and positive range of NumPaletteIndicesIdc may depend on MaxPaletteIndex, PRED, and a current CU size.

As described above, num_palette_indices_idc_abs equals abs(NumPaletteIndicesIdc), which is abs(NumPaletteIndices−PRED). Because the negative and positive range of the NumPaletteIndicesIdc may be different, e.g., the positive range may be greater than the negative range, in some cases the sign of NumPaletteIndicesIdc can be inferred. That is, if num_palette_indices_idc_abs is greater than or equal to PRED, NumPaletteIndicesIdc will have a positive value. Thus, in the case where the value of num_palette_indices_idc_abs is greater than or equal to PRED, num_palette_indices_idc_sign_flag does not need to be included in a bitstream. That is, for some values of num_palette_indices_idc_abs, a decoder may infer the sign of NumPaletteIndicesIdc. It should be noted that in the case where num_palette_indices_idc_abs equals zero, num_palette_indices_idc_sign_flag does not need to be included in a bitstream.

In one example, num_palette_indices_idc_sign_flag may be conditionally signalled based on num_palette_indices_idc_abs. Examples of conditional signalling are listed below.
num_palette_indices_idc_abs
if(num_palette_indices_idc_abs<PRED && num_palette_indices_idc_abs>0)
num_palette_indices_idc_sign_flag

When PRED equals 2*MaxPaletteIndex, num_palette_indices_idc_sign_flag may be conditionally signalled as follows:
num_palette_indices_idc_abs
if(num_palette_indices_idc_abs<2*MaxPaletteIndex && num_palette_indices_idc_abs>0)
num_palette_indices_idc_sign_flag

A decoder receiving num_palette_indices_idc_abs and conditionally receiving num_palette_indices_idc_sign_flag may derive NumPaletteIndices. An example of deriving NumPaletteIndices is listed below:

NumPaletteIndices=PRED+NumPaletteIndicesIdc
where NumPaletteIndicesIdc may be derived as:
if (num_palette_indices_idc_sign_flag==0)
   NumPaletteIndicesIdc=num_palette_indices_idc_abs
else
   NumPaletteIndicesIdc=−num_palette_indices_idc_abs

It should be noted that the condition (num_palette_indices_idc_sign_flag==0) may occur when num_palette_indices_idc_sign_flag is not present in a bitstream. Referring again to FIG. 2, intra-frame prediction processing unit 212 may be configured to output syntax elements num_palette_indices_idc_abs and num_palette_indices_idc_sign_flag to entropy encoding unit 220. Entropy encoding unit 220 may entropy encode num_palette_indices_idc_abs and num_palette_indices_idc_sign_flag as described in detail below.

As described above, the derivation of variable NumPaletteIndices and the resulting binarization of num_palette_indices_idc in JCTVC-T1005 may be less than ideal. In one example, as an alternative to generating syntax elements num_palette_indices_idc_abs and num_palette_indices_idc_sign_flag, video encoder 200 and/or intra-frame prediction processing unit 212 may be configured to generate syntax element num_palette_indices_idc in a more efficient manner than provided in JCTVC-T1005. That is, in one example, num_palette_indices_idc may be defined as follows:

num_palette_indices_idc is an indication of the number of palette indices signalled for the current block. When num_palette_indices_idc is not present, it is inferred to be equal to 0. The variable NumPaletteIndices specifies the number of palette indices signalled for the current block and may be derived as follows:

NumPaletteIndices=num_palette_indices_idc−MaxPaletteIndex

where all indices in a current palette table shall be used in the index mapping process at least one time so that the syntax element num_palette_indices_idc is always greater than or equal to MaxPaletteIndex.

A num_palette_indices_idc having the above definition may be referred to herein as restricted num_palette_indices_idc. In this manner, restricted num_palette_indices_idc is restricted to be non-negative value so that the complex derivations of NumPaletteIndices from num_palette_indices_idc described above with respect to JCTVC-T1005 can be avoided. Intra-frame prediction processing unit 212 may be configured to output syntax element restricted num_palette_indices_idc to entropy encoding unit 220. Entropy encoding unit 220 may entropy encode restricted num_palette_indices_idc as described in detail below.

Referring again to FIG. 2, motion compensation unit 214 and motion estimation unit 216 may be configured to perform inter-prediction coding for a current video block. It should be noted, that although illustrated as distinct, motion compensation unit 214 and motion estimation unit 216 may be highly integrated. Motion estimation unit 216 may be configured receive source video blocks and calculate a motion vector for PUs of a video block. A motion vector may indicate the displacement of a PU of a video block within a current video frame relative to a predictive block within a reference frame. Inter-prediction coding may use one or more reference frames. Further, motion prediction may be uni-predictive (use one motion vector) or bi-predictive (use two motion vectors). Motion estimation unit 216 may be configured to select a predictive block by calculating a pixel difference determined by, for example, sum of absolute difference (SAD), sum of square difference (SSD), or other difference metrics.

As described above, a motion vector may be determined and specified according to motion vector prediction. Motion estimation unit 216 may be configured to perform motion vector prediction, as described above, as well as other so-called Advance Motion Vector Predictions (AMVP). For example, motion estimation unit 216 may be configured to perform temporal motion vector prediction (TMVP), support “merge” mode, and support “skip” and “direct” motion inference. For example, temporal motion vector prediction (TMVP) may include inheriting a motion vector from a previous frame.

As illustrated in FIG. 2, motion estimation unit 216 may output motion prediction data for a calculated motion vector to motion compensation unit 214 and entropy encoding unit 220. Motion compensation unit 214 may be configured to receive motion prediction data and generate a predictive block using the motion prediction data. For example, upon receiving a motion vector from motion estimation unit 216 for the PU of the current video block, motion compensation unit 214 may locate the corresponding predictive video block within a frame buffer (not shown in FIG. 2). It should be noted that in some examples, motion estimation unit 216 performs motion estimation relative to luma components, and motion compensation unit 214 uses motion vectors calculated based on the luma components for both chroma components and luma components. It should be noted that motion compensation unit 214 may further be configured to apply one or more interpolation filters to a reconstructed residual block to calculate sub-integer pixel values for use in motion estimation.

As illustrated in FIG. 2, motion compensation unit 214 and motion estimation unit 216 may receive reconstructed video block via filtering unit 218. Filter unit 218 may be configured to perform deblocking and/or Sample Adaptive Offset (SAO) filtering. Deblocking refers to the process of smoothing the boundaries of reconstructed video blocks (e.g., make boundaries less perceptible to a viewer). SAO filtering is a non-linear amplitude mapping that may be used to improve reconstruction by adding an offset to reconstructed video data.

Referring again to FIG. 2, entropy encoding unit 220 receives quantized transform coefficients and predictive syntax data (i.e., intra-prediction data and motion prediction data). It should be noted that in some examples, coefficient quantization unit 206 may perform a scan of a matrix including quantized transform coefficients before the coefficients are output to entropy encoding unit 220. In other examples, entropy encoding unit 220 may perform a scan. Entropy encoding unit 220 may be configured to perform entropy encoding according to one or more of the techniques described herein. Entropy encoding unit 220 may be configured to output a compliant bitstream, i.e., a bitstream that a video decoder can receive and reproduce video data therefrom.

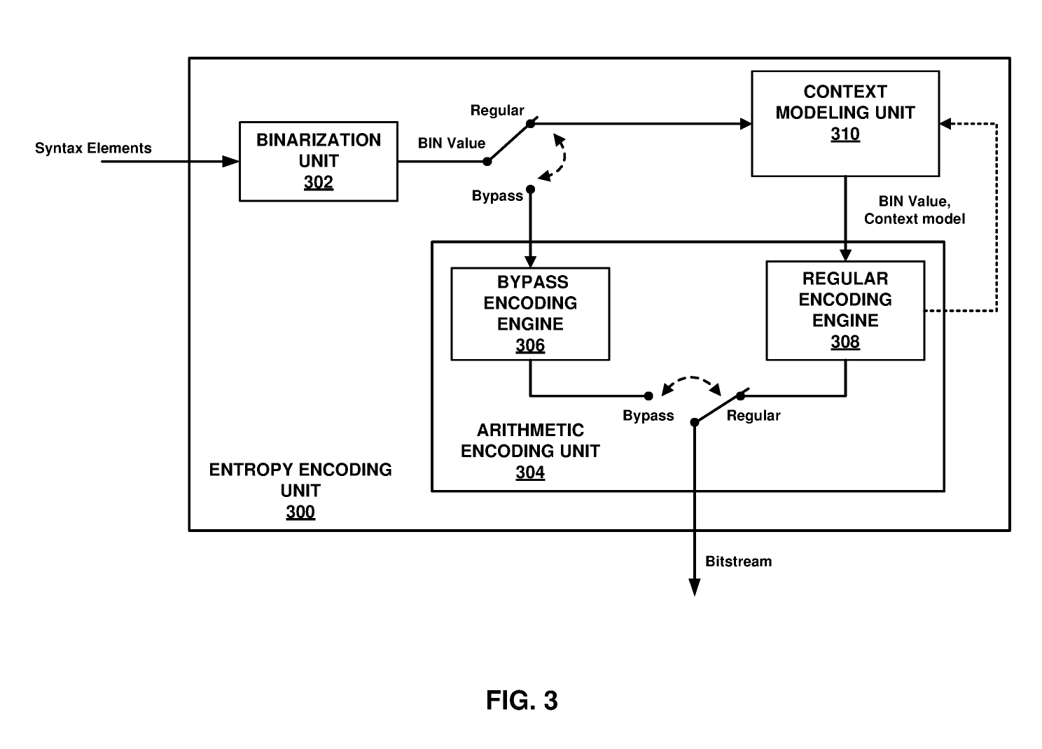

FIG. 3 is a block diagram illustrating an example of an entropy encoder that may be configured to encode syntax elements according to one or more techniques of this disclosure. Entropy encoding unit 300 may include a context adaptive entropy encoding unit, e.g., a CABAC encoder. As illustrated in FIG. 3, entropy encoding unit 300 includes binarization unit 302, an arithmetic encoding unit 304, including a bypass encoding engine 306 and a regular encoding engine 308, and context modeling unit 310. Entropy encoding unit 300 may receive one or more syntax elements, such as syntax elements num_palette_indices_idc_abs and num_palette_indices_idc_sign_flag described above. Further, in one example, entropy encoding unit 300 may receive restricted num_palette_indices_idc.

Binarization unit 302 may be configured to receive a syntax element and produce a bin string (i.e., binary string). Binarization unit 302 may use, for example, any one or combination of the binarization techniques described above. Further, in some cases, binarization unit 302 may receive a syntax element as a binary string and simply pass-through the bin values. In one example, binarization unit 302 receives syntax element num_palette_indices_idc_abs and produces bin values according to the following binarization:
Input to this process is a request for a binarization for the syntax element num_palette_indices_idc_abs, MaxPaletteIndex, and nCbS.
Output of this process is the binarization of the syntax element.
The variables cRiceParam is derived as follows:

cRiceParam=1+MaxPaletteIndex/6
The variable cMax is derived from cRiceParam as:

cMax=4<<cRiceParam
The binarization of the syntax element num_palette_indices_idc_abs is a concatenation of a prefix bin string and (when present) a suffix bin string. For the derivation of the prefix bin string, the following applies:
   The prefix value of num_palette_indices_idc_abs, prefixVal, is derived as follows:

prefixVal=Min(cMax, num_palette_indices_idc_abs)
The prefix bin string is specified by invoking the TR binarization process as specified [above] for prefixVal with the variables cMax and cRiceParam as inputs.
When the prefix bin string is equal to the bit string of length 4 with all bits equal to 1, the suffix bin string is present and it is derived as follows:
   The suffix value of num_palette_indices_idc_abs, suffixVal, is derived as follows:

suffixVal=num_palette_indices_idc_abs−cMax
The suffix bin string is specified by invoking the k-th order EGk binarization process as specified [above] for the binarization of suffixVal with the Exp-Golomb order k set equal to cRiceParam+1.

Further, in one example, binarization unit 302 receives syntax element num_palette_indices_idc_sign and produces bin values according to a fix length binarization process, where cMax equals 1.

Further, in one example, binarization unit 302 receives syntax element restricted num_palette_indices_idc and in one example the binarization of restricted num_palette_indices_idc may be similar to the binarization of num_palette_indices_idc in JCTVC-T1005.

In this manner, entropy encoding unit 300 may be configured to entropy encode a syntax element having a value that is an indication of the number of palette indices signalled for the current block based using an exponential Golomb rice coding where a rice parameter setting variable is based at least in part on the maximum possible value for a palette index for the current coding unit.

Referring again to FIG. 3, arithmetic encoding unit 304 is configured to receive a bin string from binarization unit 302 and perform arithmetic encoding on the bin string. As illustrated in FIG. 3, arithmetic encoding unit 304 may receive bin values from a bypass path or the regular coding path. In the case where arithmetic encoding unit 304 receives bin values from a bypass path, bypass encoding engine 306 may perform arithmetic encoding on bin values without utilizing an adaptive context assigned to a bin value. In one example, bypass encoding engine 306 may assume equal probabilities for possible values of a bin.

In the case where arithmetic encoding unit 304 receives bin values through the regular path, context modeling unit 310 may provide a context model, such that regular encoding engine 308 may perform arithmetic encoding using an identified context model. The context models may be defined according to a video coding standard, such as HEVC. The context models may be stored in a memory. Context modeling unit 310 may include a series of indexed tables and/or utilize mapping functions to determine a context model for a particular bin. After encoding a bin value, regular encoding engine 308 may update a context model based on the actual bin values.

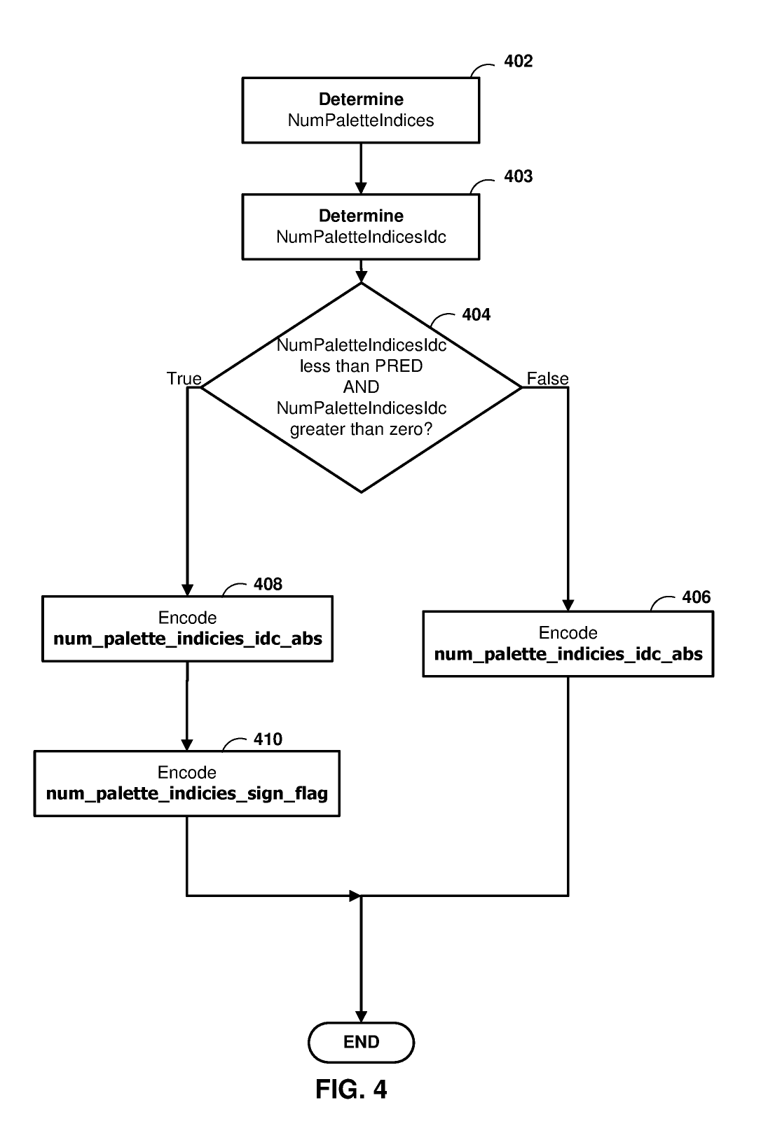

FIG. 4 is a flowchart illustrating encoding palette coding syntax elements according to one or more techniques of this disclosure. As described above, video encoder 200 may be configured to encode syntax elements num_palette_indices_idc_abs and num_palette_indices_idc_sign_flag described above.

As illustrated in FIG. 4, video encoder 200 determines a number of palette indices signalled for the current block (e.g., NumPaletteIndices) (402). As described above, a number of palette indices signalled for a current block may include a number of signalled palette index values and a number of signalled copy above mode runs. Video encoder 200 generates an indicator of the number of palette indices signalled for the current block (e.g., NumPaletteIndicesIdc) (403). As described above, in one example, an indicator of the number of palette indices signalled for the current block may equal the difference of a number of palette indices signalled for a current block and a predictor value. As described above, in one example, the predictor value may be equal to a multiplier times a maximum possible value for a palette index for the current coding unit (e.g., 2*MaxPaletteIndex). Video encoder 200 determines if the value of the indicator of the number of palette indices signalled for the current block is less than a predictor value and greater than zero (404). That is, video encoder 200 determines if the value of the indicator of the number of palette indices signalled for the current block is within the inclusive range of PRED-1 to 1.

Upon determining that the indicator of the number of palette indices signalled for the current block is not within the inclusive range of PRED-1 to 1, video encoder 200 encodes syntax element num_palette_indices_idc_abs (406). That is, in the case where NumPaletteIndicesIdc is not within the inclusive range of PRED-1 to 1, syntax element num_palette_indices_sign_flag is not included in a bitstream. In this case, as described above, a video decoder may infer that variable NumPaletteIndicesIdc is zero or positive. In one example, encoding syntax element num_palette_indices_idc_abs may include entropy encoding num_palette_indices_idc_abs according to the example binarization described above. That is, video encoder 200 may entropy encode num_palette_indices_idc_abs using exponential Golomb rice coding where a rice parameter setting variable is based at least in part on the maximum possible value for a palette index for the current coding unit (e.g., cRiceParam=1+MaxPaletteIndex/6).

Upon determining that the indicator of the number of palette indices signalled for the current block is less than a predictor value and not equal to zero (i.e., within the inclusive range of PRED-1 to 1), in addition to encoding syntax element num_palette_indices_idc_abs (408), video encoder 200 encodes syntax element num_palette_indices_idc_sign_flag (410). In one example, encoding syntax element num_palette_indices_idc_sign_flag may include entropy encoding num_palette_indices_idc_sign_flag according to the example binarization described above (e.g., fixed length).

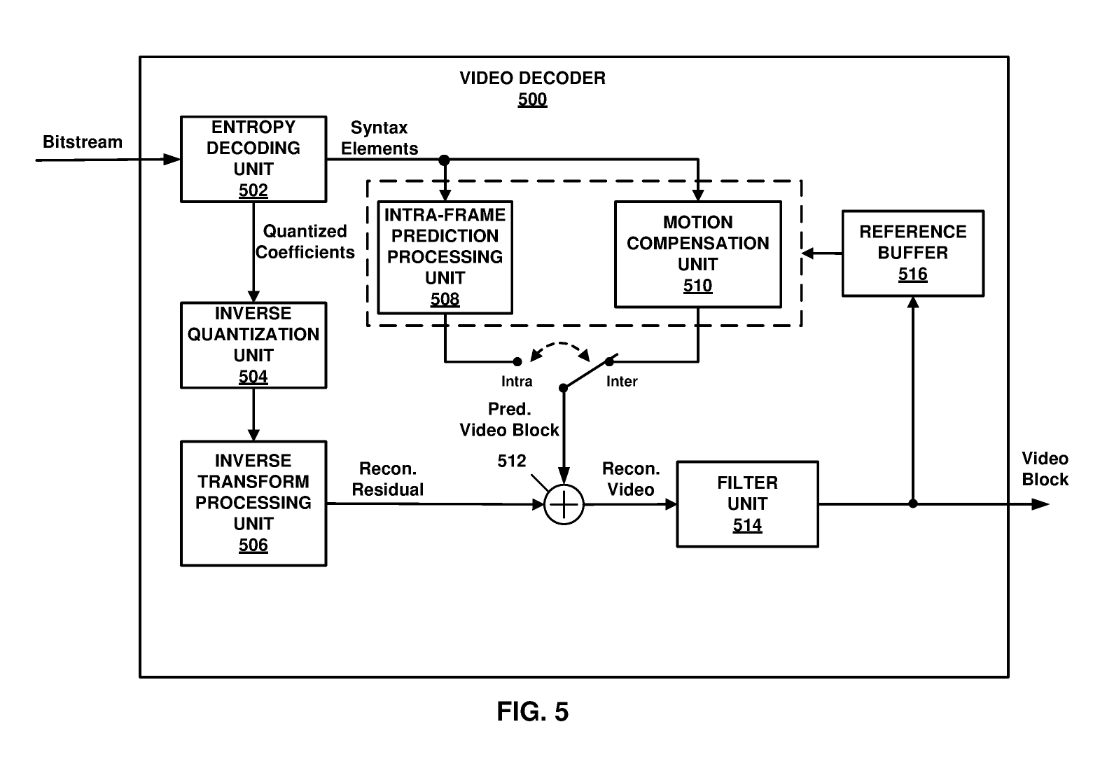

FIG. 5 is a block diagram illustrating an example of a video decoder that may be configured to decode video data according to one or more techniques of this disclosure. In one example, video decoder 500 may be configured to parse a syntax element indicating the absolute value of the difference of the number of palette indices signalled for a current coding unit and a predictor term and determine the number of palette indices signalled for a current coding unit based on the syntax element.

Video decoder 500 may be configured to perform intra-prediction decoding and inter-prediction decoding and, as such, may be referred to as a hybrid decoder. In the example illustrated in FIG. 5 video decoder 500 includes an entropy decoding unit 502, inverse quantization unit 504, inverse transformation processing unit 506, intra-frame prediction processing unit 508, motion compensation unit 510, summer 512, filter unit 514, and reference buffer 516. Video decoder 500 may be configured to decode video data in a manner consistent with a video coding standard. It should be noted that although example video decoder 500 is illustrated as having distinct functional blocks, such an illustration is for descriptive purposes and does not limit video decoder 500 and/or sub-components thereof to a particular hardware or software architecture. Functions of video decoder 500 may be realized using any combination of hardware, firmware and/or software implementations.

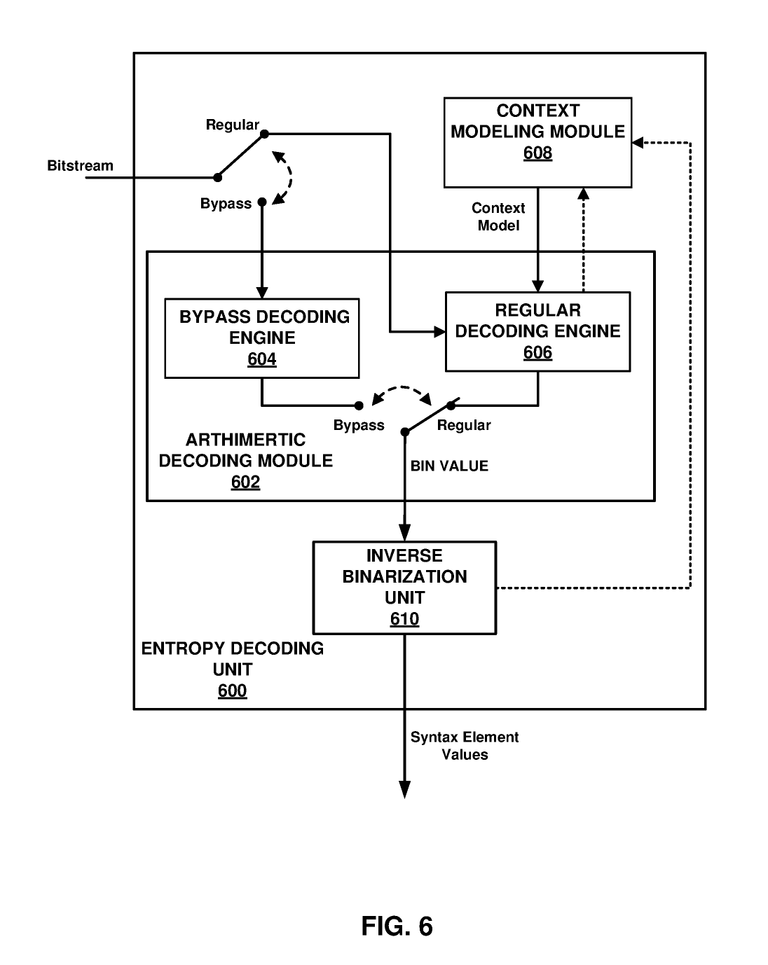

As illustrated in FIG. 5, entropy decoding unit 502 receives an entropy encoded bitstream. Entropy decoding unit 502 may be configured to decode quantized syntax elements and quantized coefficients from the bitstream according to a process reciprocal to an entropy encoding process. Entropy decoding unit 502 may be configured to perform entropy decoding according any of the entropy coding techniques described above. Entropy decoding unit 502 may parse an encoded bitstream in a manner consistent with a video coding standard. In one example, entropy decoding unit 502 may be configured to parse syntax element num_palette_indices_idc_abs and conditionally parse syntax element num_palette_indices_idc_sign_flag described above. Further, in one example, entropy decoding unit 502 may be configured to parse syntax element restricted num_palette_indices_idc. An example entropy decoding process is described below with respect to FIG. 6.

As illustrated in FIG. 5, inverse quantization unit 504 receives quantized transform coefficients from entropy decoding unit 502. Inverse quantization unit 504 may be configured to apply an inverse quantization. Inverse transform processing unit 506 may be configured to perform an inverse transformation to generate reconstructed residual data. The techniques respectively performed by inverse quantization unit 504 and inverse transform processing unit 506 may be similar to techniques performed by inverse quantization/transform processing unit 208 described above. An inverse quantization process may include a conventional process, e.g., as defined by the H.265 decoding standard. Further, the inverse quantization process may also include use of a quantization parameter QP. Inverse transform processing unit 506 may be configured to apply an inverse DCT, an inverse DST, an inverse integer transform, or a conceptually similar inverse transform process, to the transform coefficients in order to produce residual blocks in the pixel domain. As illustrated in FIG. 5, reconstructed residual data may be provided to summer 512. Summer 512 may add reconstructed residual data to a predictive video block and generate reconstructed video data. A predictive video block may be determined according to a predictive video technique (i.e., intra-frame prediction and inter-frame prediction).

Intra-frame prediction processing unit 508 may be configured to receive intra-frame prediction syntax elements and retrieve a predictive video block from reference buffer 516. Reference buffer 516 may include a memory device configured to store one or more frames of video data. Intra-frame prediction syntax elements may identify an intra-prediction mode, such as the intra-prediction modes described above. In one example, intra-frame prediction processing unit 508 may receive the syntax elements described above and reconstruct a video block using palette mode coding.

Motion compensation unit 510 may receive inter-prediction syntax elements and generate motion vectors to identify a prediction block in one or more reference frames stored in reference buffer 516. As described above, intra-picture block copying prediction may be implemented as part of inter-prediction coding, as such, in one example, motion compensation unit 510 may be configured to receive syntax elements described above and reconstruct a video block using intra-picture block copying prediction.

Motion compensation unit 510 may produce motion compensated blocks, possibly performing interpolation based on interpolation filters. Identifiers for interpolation filters to be used for motion estimation with sub-pixel precision may be included in the syntax elements. Motion compensation unit 510 may use interpolation filters to calculate interpolated values for sub-integer pixels of a reference block. Filter unit 514 may be configured to perform filtering on reconstructed video data. For example, filter unit 514 may be configured to perform deblocking and/or SAO filtering, as described above with respect to filter unit 218. Further, it should be noted that in some examples, filter unit 514 may be configured to perform proprietary discretionary filter (e.g., visual enhancements). As illustrated in FIG. 5, a video block may be output by video decoder 500. In this manner, video decoder 500 may be configured to generate reconstructed video data.

As described above, entropy decoding unit 502 may be configured to perform entropy decoding. FIG. 6 is a block diagram illustrating an example entropy decoding unit that may implement one or more of the techniques described in this disclosure. Entropy decoding unit 600 receives an entropy encoded bitstream and decodes syntax elements from the bitstream. As illustrated in FIG. 6, entropy decoding unit 600 includes an arithmetic decoding unit 602, which may include a bypass decoding engine 604 and a regular decoding engine 606. Entropy decoding unit 600 also includes context modeling unit 608 and inverse binarization unit 610. Entropy decoding unit 600 may perform reciprocal functions to entropy encoding unit 300 described above with respect to FIG. 3. In this manner, entropy decoding unit 600 may perform entropy decoding based on the entropy coding techniques described herein.

Arithmetic decoding unit 602 receives an entropy encoded bitstream. As shown in FIG. 6, arithmetic decoding unit 602 may process encoded bin values according to a bypass path or the regular coding path. An indication whether an encoded bin value should be processed according to a bypass path or a regular pass may be signaled in the bitstream with higher level syntax. Consistent with the CABAC coding process described above, in the case where arithmetic decoding unit 602 receives bin values from a bypass path, bypass decoding engine 604 may perform arithmetic decoding on bin values without utilizing a context assigned to a bin value. In one example, bypass decoding engine 604 may assume equal probabilities for possible values of a bin.

In the case where arithmetic decoding unit 602 receives bin values through the regular path, context modeling unit 608 may provide a context model, such that regular decoding engine 606 may perform arithmetic decoding based on the context models provided by context modeling unit 608. Context modeling unit 608 may include a memory device storing a series of indexed tables and/or utilize mapping functions to determine a context and a context variable. After decoding a bin value, regular decoding engine 606, may update a context model based on the decoded bin values.

Inverse binarization unit 610 may perform an inverse binarization on a bin value and output syntax element values. In one example, inverse binarization unit 610 may be configured to perform an inverse binarization on syntax elements according to the respective binarization processes described above. In one example, inverse binarization unit 610 may be configured to perform an inverse binarization on syntax elements num_palette_indices_idc_abs and num_palette_indices_idc_sign_flag. In one example, inverse binarization unit 610 may be configured to perform an inverse binarization on syntax elements restricted num_palette_indices_idc. Further, inverse binarization unit may use a bin matching function to determine if a bin value is valid. Inverse binarization unit 610 may also update the context modeling unit 608 based on the matching determination.

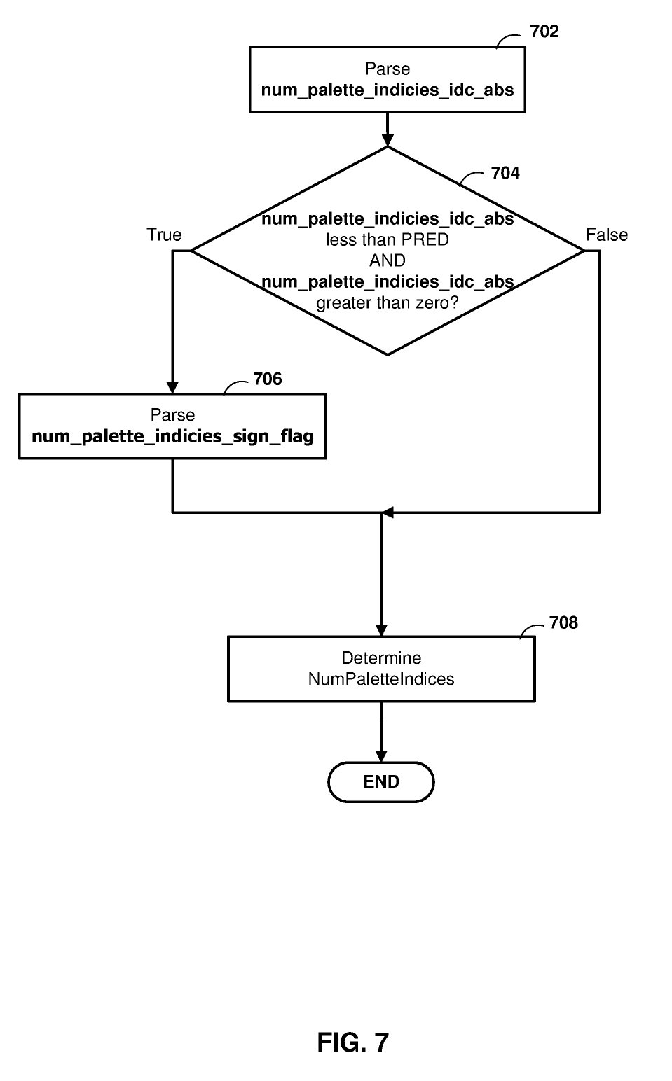

FIG. 7 is a flowchart illustrating parsing palette coding syntax elements according to one or more techniques of this disclosure. As described above, video decoder 500 may be configured to parse num_palette_indices_idc_abs and num_palette_indices_idc_sign_flag syntax elements, described above.

As illustrated in FIG. 7, video decoder 500 parses a syntax element indicating the absolute value of the difference of the number of palette indices signalled for a current coding unit and a predictor term (702). In one example, the syntax element may include the syntax element num_palette_indices_idc_abs and parsing num_palette_indices_idc_abs may include performing an inverse binarazation. In one example, entropy decoding num_palette_indices_idc_abs may include performing an inverse binarization according to the techniques described above. Video decoder 500 determines whether the value of num_palette_indices_idc_abs is less than the predictor term and greater than zero (704). That is, video decoder 500 determines whether the value of num_palette_indices_idc_abs is within the inclusive range of PRED-1 to 1. As described above, in one example the predictor term may be equal to a multiplier times a maximum possible value for a palette index for the current coding unit (e.g., 2*MaxPaletteIndex).

Upon determining that the value of num_palette_indices_idc_abs is not within the inclusive range of PRED-1 to 1, (e.g., within the inclusive range of PRED to nCbS-PRED) video decoder determines NumPaletteIndices (at 708) without parsing syntax element num_palette_indices_sign_flag, i.e., syntax element num_palette_indices_sign_flag is not included in a bitstream. In this case, as described above, video decoder 500 may infer that variable NumPaletteIndicesIdc is zero or positive.

Upon determining that the value of num_palette_indices_idc_abs is within the inclusive range of PRED-1 to 1, video decoder 500 parses num_palette_indices_sign_flag (706), i.e., syntax element num_palette_indices_sign_flag is included in a bitstream. In one example, parsing syntax element num_palette_indices_idc_sign_flag may include entropy decoding num_palette_indices_idc_sign_flag according to a fixed length binarization. At 708 video decoder 500 determines NumPaletteIndices. In one example video decoder 500 may determine NumPaletteIndices as follows:

NumPaletteIndices=PRED+NumPaletteIndicesIdc
where NumPaletteIndicesIdc may be derived as:
if (num_palette_indices_idc_sign_flag==0)
   NumPaletteIndicesIdc=num_palette_indices_idc_abs
else
   NumPaletteIndicesIdc=−num_palette_indices_idc_abs

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding a syntax element associated with video data, the method comprising:
determining a number of palette indices signalled for a current coding unit; and
generating an indication of the number of palette indices signalled for a current coding unit, wherein generating the indication includes determining the difference of the number of palette indices signalled for a current coding unit and a predictor term.

2. The method of claim 1, wherein the predictor term is a predetermined constant value.

3. The method of claim 1, wherein the predictor term is equal to a multiplier times a maximum possible value for a palette index for the current coding unit.

4. The method of claim 1, further comprising entropy encoding a syntax element representing the difference of the number of palette indices signalled for a current coding unit and a predictor term according to an exponential Golomb rice coding.

5. The method of claim 1, wherein a number of palette indices signalled for a current coding unit includes a number of signalled palette index values and a number of signalled copy above mode runs.

6. A device for encoding a syntax element associated with video data, the device comprising one or more processors configured to:
determine a number of palette indices signalled for a current coding unit; and
generate an indication of the number of palette indices signalled for a current coding unit, wherein generating the indication includes determining the difference of the number of palette indices signalled for a current coding unit and a predictor term.

7. The device of claim 6, wherein the predictor term is a predetermined constant value.

8. The device of claim 6, wherein the predictor term is equal to a multiplier times a maximum possible value for a palette index for the current coding unit.

9. The device of claim 6, wherein the one or more processors are further configured to entropy encode a syntax element representing the difference of the number of palette indices signalled for a current coding unit and a predictor term according to an exponential Golomb rice coding.

10. The device of claim 6, wherein a number of palette indices signalled for a current coding unit includes a number of signalled palette index values and a number of signalled copy above mode runs.

11. A method of decoding a syntax element associated with video data, the method comprising:
parsing a syntax element indicating the difference of the number of palette indices signalled for a current coding unit and a predictor term; and
determining the number of palette indices signalled for a current coding unit based on the syntax element.

12. The method of claim 11, wherein the predictor term is a predetermined constant value.

13. The method of claim 11, wherein the predictor term is equal to a multiplier times a maximum possible value for a palette index for the current coding unit.

14. The method of claim 11, wherein parsing the syntax element representing the difference of the number of palette indices signalled for a current coding unit and a predictor term includes entropy decoding the syntax element according to an exponential Golomb rice coding.

15. The method of claim 11, wherein a number of palette indices signalled for a current coding unit includes a number of signalled palette index values and a number of signalled copy above mode runs.

16. A device for decoding a predictive syntax element associated with video data, the device comprising one or more processors configured:
parse a syntax element indicating the difference of the number of palette indices signalled for a current coding unit and a predictor term; and
determine the number of palette indices signalled for a current coding unit based on the syntax element.

17. The device of claim 16, wherein the predictor term is a predetermined constant value.

18. The device of claim 16, wherein the predictor term is equal to a multiplier times a maximum possible value for a palette index for the current coding unit.

19. The device of claim 16, wherein parsing the syntax element representing the difference of the number of palette indices signalled for a current coding unit and a predictor term includes entropy decoding the syntax element according to an exponential Golomb rice coding.

20. The device of claim 16, wherein a number of palette indices signalled for a current coding unit includes a number of signalled palette index values and a number of signalled copy above mode runs.
